(19) United States
(12) Patent Application Publication
(10) Pub. No.: US 2012/0003447 A1
(43) Pub. Date: Jan. 5, 2012

(54) WIPES HAVING A NON-HOMOGENEOUS STRUCTURE

(75) Inventors: Hugh Joseph O'Donnell, Cincinnati, OH (US); Karen Denise McAffry, Cincinnati, OH (US); Joerg Mueller, Karben (DE); Luis Omar Gonzalez-Mendez, Cincinnati, OH (US)

(73) Assignee: The Procter & Gamble Company, Cincinnati, OH (US)

(21) Appl. No.: 13/173,436

(22) Filed: Jun. 30, 2011

Related U.S. Application Data
(60) Provisional application No. 61/360,946, filed on Jul. 2, 2010.

(51) Int. Cl. B32B 7/02

(52) U.S. Cl. 428/212

(57) ABSTRACT

A wipe exhibiting many of the properties that consumers desire for a wipe, i.e. softness, strength, coverage, flexibility and a process of making a wipe at competitive costs are disclosed. The wipe comprises a sheet of fibrous material having regions of a first basis weight and regions of a second basis weight.

### CROSS-REFERENCE TO RELATED APPLICATION

This application claims the benefit of U.S. Provisional Application No. 61/360,946, filed Jul. 2, 2010, the substance of which is incorporated herein by reference.

### TECHNICAL FIELD

Wipes, either dry or wet, that exhibit a right balance of properties in terms of softness, strength, flexibility, thickness, coverage and that can be produced at lower costs are provided.

### BACKGROUND

Disposable wipes, either wet or dry, are well-known and successfully commercialized for a large variety of uses. For instance, wipes may be used for cleaning hard surfaces such as floors or kitchen surfaces. Wipes may also be used for personal cleaning, for example to remove facial make-up or to clean or refresh the skin whilst traveling. Wipes are also particularly appreciated for cleaning baby's skin in the perineal area during a diaper change.

Typically, wipes comprise a substrate, in the form of a woven or nonwoven sheet. The sheet may be impregnated with a lotion composition wetting the substrate to facilitate cleaning and providing a so-called wet wipe. The lotion composition may deliver additional benefits, e.g. soothing, treating.

Various types of substrates, differing in their visual and tactile properties, may be utilized for manufacturing disposable wipes. When wipes are intended to be used as personal care wipes, such as baby wipes, facial cleansing wipes, intimate cleansing wipes, and the like, softness, flexibility, coverage, effective cleaning ability, strength are properties that matter for the consumers. Thus, over the past decades, research and development efforts were aimed at developing new substrates suitable for manufacturing wipes meeting these expectations.

In the course of these research and developments, it was found that maintaining a right balance of properties is challenging. Typically, when one property is improved, other properties of the substrate may be adversely affected. In addition to this challenge, manufacturers have to control the manufacturing/producing costs in order to deliver wipes at competitive prices, which can find wide acceptance among consumers. This is to the more challenging than in recent years, commodities prices, e.g. raw materials costs, have considerably increased.

To reduce cost, wipes manufacturers have attempted to reduce the overall amount of fibers in these materials to provide substrates of lower basis weights. However, this solution is not completely satisfactory. Basis weight reduction may be noticeable to consumers, either visually or to the touch. This mere sensorial analysis of the wipes may reduce the confidence consumers have in the ability of the wipes to perform the cleaning task efficiently, the wipes appearing more flimsy. They may also feel concerned by the fact that the wipe may not protect efficiently their hands from soiling during the cleaning task. Furthermore, basis weight reduction may not only affect the perception the consumers may have of the products. In some instances, basis weight reduction may also affect the physical properties of the wipes. For instance, the strength or coverage of the wipes may be reduced to levels more or less acceptable by the consumers.

Thus, it remains a need for wipes, either dry or wet, that would exhibit a right balance of properties, e.g. softness, strength, flexibility, thickness, coverage and that could be produced at lower costs. The reduction in the manufacturing costs should not affect the perception the consumers have of the wipes, nor their cleaning efficiency. The wipes should remain thick enough to make the consumer confident in the cleaning performance of the wipes and provide good hand coverage during the cleaning tasks. The wipes should also be soft to be gentle to the skin, flexible, strong and visually attractive, this at low costs.

### SUMMARY

A wipe comprising a sheet of fibrous material, said sheet having two side panels and a central panel, where each of said side panels includes at least one region of a first basis weight, said central panel includes one region of a second basis weight, said region of a second basis weight representing from 25 to 100% of the total surface area of the central panel, and wherein said first basis weight is lower than said second basis weight.

### BRIEF DESCRIPTION OF THE DRAWINGS

FIG. 1 is a schematic top view of a wipe in accordance with one or more embodiments of the invention.

FIG. 2 is a schematic top view of a wipe in accordance with one or more embodiments of the invention.

FIG. 3 is a schematic top view of a wipe in accordance with one or more embodiments of the invention.

FIG. 4 is a schematic top view of a wipe in accordance with one or more embodiments of the invention.

FIG. 5 is a schematic representation of a device for mechanically activating a fibrous material.

FIG. 6 is a schematic cross-sectional view of a device for mechanically activating a fibrous material.

### DETAILED DESCRIPTION

A “region” as used herein is defined by a portion of the sheet that is homogeneous in a selected defining criterion, herein the basis weight, and is distinguished from neighboring portions by this criterion. For instance, a region as used herein corresponds to a portion of the wipe wherein the basis weight is homogeneous. The wipes of the present disclosure may comprise regions of a first basis weight, regions of a second basis weight and eventually regions of a third basis weight. It will be apparent to one skilled in the art that there may be small transition regions having a basis weight intermediate the first basis weight and the second basis weight or third basis weight. These transition regions by themselves may be not significant enough in area to be considered as comprising a basis weight distinct from the basis weight of the regions of first basis weight and second basis weight. Such transitional regions are within the normal manufacturing variations known and inherent in producing the fibrous structure.

It has been found that wipes having a reduced basis weight in target regions meet the above needs. Indeed, such wipes provide optimized cleaning performances and exhibit an appropriate balance of properties in terms of visual appearance, softness, drapability, flexibility, strength as well as can be produced with substantial cost savings. The term “basis weight” as used herein refers to the mass of dry fibrous material per unit area, i.e. the mass of dry sheet per unit area, e.g. gram per square centimeter.

As used herein with respect to fibrous materials, the term “machine-direction” refers to the direction of travel as the fibrous material is produced, for example on nonwoven making equipment. Likewise, the term “cross-direction” refers to the direction in the plane of the fibrous material perpendicular to the machine-direction. With respect to individual wipes or sheets, the terms “machine-direction” and “cross-machine direction” refer to the corresponding directions of the wipes/sheets with respect to the fibrous material the wipe/sheet was made from.

The present disclosure is directed to a distinctive wipe, either dry or wet, comprising a sheet of fibrous material having a non-homogeneous structure, i.e. regions of different basis weight.

The term “wipe” as used herein, also known as “cleaning sheet”, refers to an article comprising a sheet of fibrous material. Wipes, either dry or wet, are intended to be used for removal of a substance from a surface or object which is animate or inanimate, or alternatively, application of a material to a surface or object which is animate or inanimate. For instance, wipes may be used for cleaning hard surfaces, such as floors. Wipes may also be used for human or animal cleansing or wiping such as anal cleansing, perineal cleansing, genital cleansing, and face and hand cleansing. Wipes may also be used for application of substances to the body, including but not limited to application of make-up, skin conditioners, ointments, and medications. They may also be used for cleaning or grooming of pets. Additionally, they may be used for general cleansing of surfaces and objects, such as household kitchen and bathroom surfaces, eyeglasses, exercise and athletic equipment, automotive surfaces, and the like.

By “sheet of fibrous material” as used herein, it is meant a piece of fibrous material suitable for use as, or in a wipe. Suitable fibrous materials include woven and nonwoven materials, comprising natural fibers or synthetic fibers or combinations thereof. Examples of natural fibers may include cellulosic natural fibers, such as fibers from hardwood sources, softwood sources, or other non-wood plants. The natural fibers may comprise cellulose, starch and combinations thereof. The synthetic fibers can be any material, such as, but not limited to, those selected from the group consisting of polyesters (e.g., polyethylene terephthalate), polyolefins, polypropylenes, polyethylenes, polyethers, polyamides, polyesteramides, polyvinylalcohols, polyhydroxyalkanoates, polysaccharides and combinations thereof. Further, the synthetic fibers can be a single component (i.e., single synthetic material or mixture makes up entire fiber), bi-component (i.e., the fiber is divided into regions, the regions including two or more different synthetic materials or mixtures thereof and may include co-extruded fibers and core and sheath fibers) and combinations thereof. Bi-component fibers can be used as a component fiber of the fibrous material, and/or they may be present to act as a binder for the other fibers present in the material. Any or all of the synthetic fibers may be treated before, during, or after manufacture to change any desired properties of the fibers.

“Nonwoven material” as used herein refers to a manufactured web of directionally or randomly orientated fibers, bonded by friction, and/or cohesion and/or adhesion, excluding paper and products which are woven, knitted, tufted, stitch-bonded incorporating binding yarns or filaments, or felted by wet-milling, whether or not additionally needled. Nonwoven materials may be manufactured by a wide number of known processes. Non-limiting examples of processes include spunbonding, meltblowing, air laying, wet laying, coform, carding, needle-punching, mechanical entangling, thermo-mechanical entangling, hydroentangling, calender bonding and combination thereof.

Suitable sheet of fibrous material include but are not limited to carded nonwovens comprising a blend of cellulosic and synthetic fibers. The cellulosic fibers may be present in an amount ranging from about 5% to about 70%, or from about 10% to about 60% or from about 20% to about 50% by weight of the fibrous material. Examples of suitable blends include blends of viscose fibers and polypropylene fibers, wherein the viscose fibers may be present in an amount ranging from about 5% to about 70%, or from about 10% to about 60% or from about 20% to about 50% by weight of the fibrous material. Polyethylene terephthalate fibers may also be added to the blend of viscose fibers and polypropylene fibers.

The sheet of fibrous material may be made of one single layer or may be made of several layers forming a composite sheet of fibrous material. For instance, the composite sheet may comprise a laminate web of two or more nonwoven webs. The laminate web may comprise spunbond layer(s) (S), and/or meltblown layer(s) (M), and/or carded layer(s) (C), and/or pulp layer(s) (P). Suitable laminate webs include, but are not limited to, SS, SP, SPC, SMS or SMMS. The sheet of fibrous material may also be combined with one or more other layers, such as layers of extensible material or inextensible material.

The sheet of fibrous material may comprise on at least one of its surface a macroscopic three dimensional pattern which may be defined by peaks and valleys. Said three dimensional patterns may be produced by hydromolding. However, any texturing processes may be suitable to provide macroscopic three dimensional patterns. Three dimensional patterns may enhance the cleaning performance of the wipe made of said sheet.

Generally, a wipe is rectangular or square in shape and is defined by two pairs of opposite sides or edges. Each wipe has a width and a length. For example, the wipe may have a length of from about 6 to about 40 cm, or from about 10 to about 25 cm, or from about 15 to about 23 cm, or from about 17 to about 21 cm and may have a width of from about 10 to 25 cm, or from about 15 to about 23 cm, or from about 17 to about 21 cm.

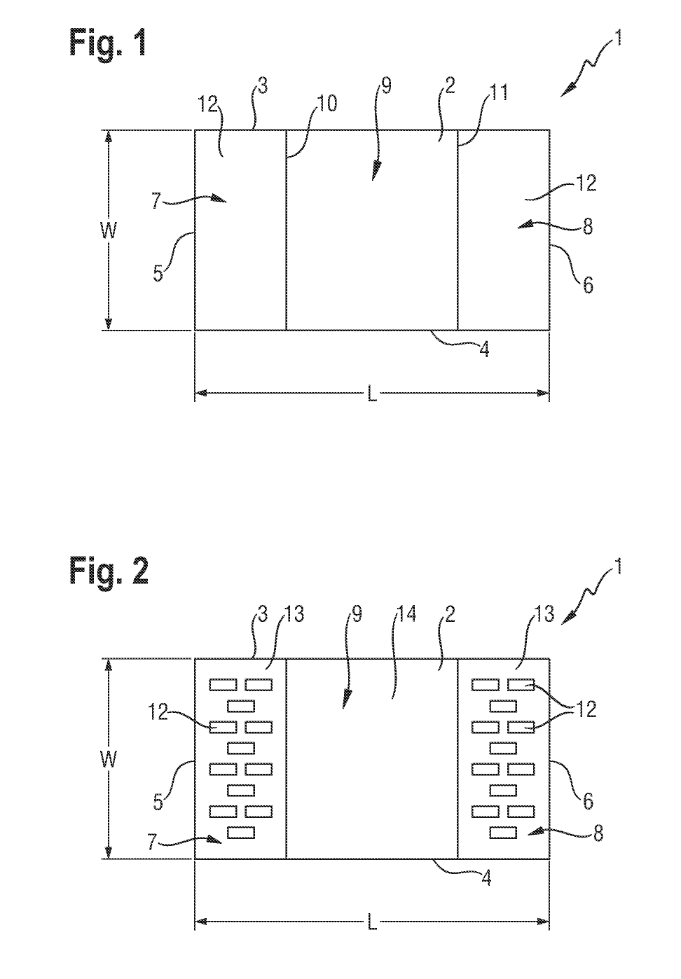

Each of FIGS. 1 to 4 illustrates a wipe 1 comprising a sheet of fibrous material 2 having a width W and a length L and defined by two pairs of opposite sides or edges 3; 4, 5; 6. The sheet 2 making the wipe according to the present disclosure has two side panels 7, 8 and a central panel 9.

Side Panels

A side panel as used herein is defined by the area of the sheet comprised between one selected edge of the sheet and a virtual line connecting the edges adjacent to said selected edge. Said virtual line may be parallel to the selected edge or may be curvilinear or may be a wavy line.

With reference to FIG. 1, the side panel referred under the reference number 7 is defined by the area of the sheet comprised between the selected edge 5 and the virtual line 10 connecting the edges 3 and 4 adjacent to the selected edge 5. The side panel referred under the reference number 8 is defined by the area of the sheet comprised between the selected edge 6 and the virtual line 11 connecting the edges 3 and 4 adjacent to the selected edge 6.

The area of the sheet comprised between the two side panels 7, 8 is referred herein as the central panel 9.

The overall dimensions of the sheet and panels thereof, i.e. side panels and central panel, are dependent on the intended application of the wipe and can be selected accordingly. However, typically, each side panel has a surface area representing up to 10% of the surface area of the sheet, or up to 20% of the total surface area of the sheet, or up to 40% of the total surface area of the sheet. In some embodiments, each side panel has a surface area representing from about 5% to about 40% of the total surface area of the sheet, or from about 10 to about 35% of the total surface area of the sheet, or from about 15 to about 30% of the total surface area of the sheet. The two side panels may have a same surface area, or may have a different surface area.

Each of the two side panels of the sheet of fibrous material may comprise one region of a first basis weight or may comprise several regions of a first basis weight. In some embodiments, the two side panels comprise respectively one region of a first basis weight. In some embodiments, the two side panels comprise respectively several regions of a first basis weight. In some embodiments, one side panel comprises one region of a first basis weight and one side panel comprises several regions of a first basis weight.

When the two side panels comprise respectively one region of a first basis weight, said region of a first basis weight may have the surface area of the side panel, i.e. the side panels 7,8 consist respectively of a region 12 of a first basis weight, as shown in FIG. 1. In those embodiments, each region of a first basis weight may have a surface area representing up to 10% of the surface area of the sheet, or up to 20% of the total surface area of the sheet, or up to 40% of the total surface area of the sheet. In some embodiments, each region of a first basis weight may have a surface area representing from about 5% to about 40% of the total surface area of the sheet, or from about 10 to about 35% or from about 15 to about 30% of the total surface area of the sheet. The two side panels may have a same surface area or may have a different surface area.

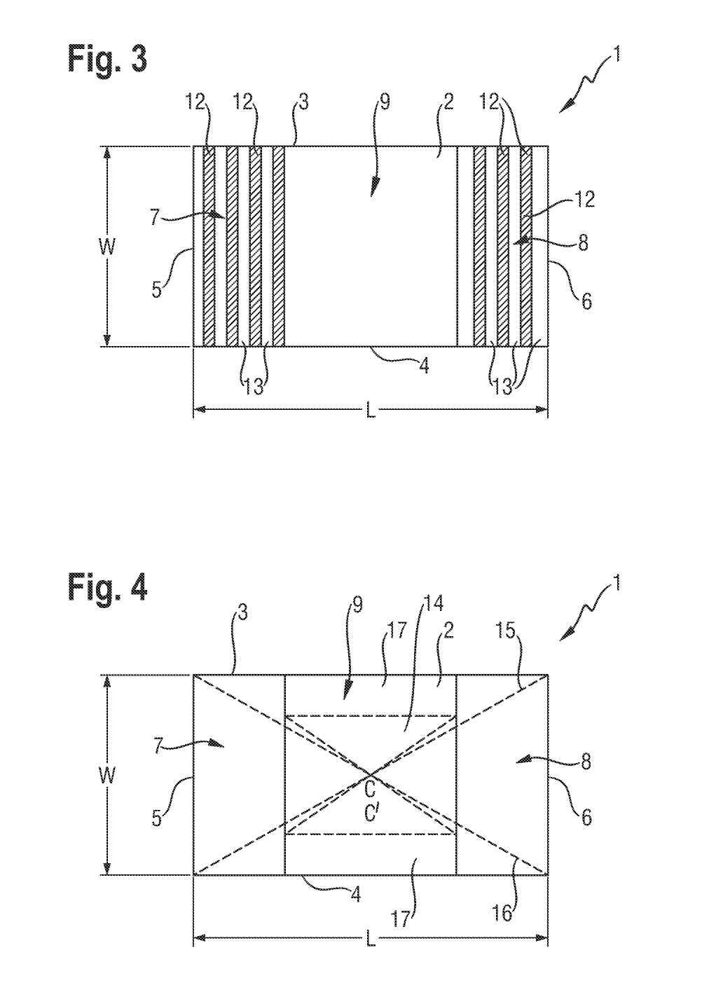

In some embodiments, the two side panels of the sheet of fibrous material comprise respectively several regions of a first basis weight, such as from about 2 to about 200 regions, or from about 2 to about 100 regions, or from about 2 to about 50 regions of a first basis weight. FIGS. 2 and 3 represent embodiments wherein the side panels 7, 8 of the sheet of fibrous material comprise several regions 12 of a first basis weight. The regions 12 of a first basis weight are discrete regions, i.e. they are separated from each others by one or more regions of a different basis weight. For instance, the regions of a first basis weight may be separated from each other by one or more regions of a second basis weight, said second basis weight being higher than the first basis weight. Alternatively, the regions of a first basis weight may be separated from each other by one or more regions of a third basis weight, said third basis weight being higher or lower than the first basis weight. FIG. 2 illustrates an embodiment wherein the regions 12 of a first basis weight in the side panels 7, 8 are separated from each other by one region 13 of a different basis weight. In said embodiment, the regions of a first basis weight 12 are discrete regions separated by one continuous region 13 of a different basis weight. FIG. 3 illustrates an embodiment wherein the regions 12 of a first basis weight in the side panels 7, 8 are separated from each others by several regions 13 of a different basis weight. In said embodiments, the regions of a first basis weight and the regions of a different basis weight, e.g. regions of a second basis weight or regions of a third basis weight, are discrete regions.

In embodiments wherein the side panels of the sheet comprise respectively several regions of a first basis weight, e.g. from about 2 to about 200, or from about 2 to about 100, or from about 2 to about 50 regions, said regions of a first basis weight may be distributed over the surface of the side panels of the sheet in a regular or irregular pattern. The regions of a first basis weight may have a variety of shape, such as squares, rectangles, dots, triangles, stripes and polygons. FIG. 2 illustrates an embodiment wherein the regions 12 of a first basis weight are rectangular and form a regular pattern. The regions of a first basis weight may also be in the form of stripes extending from one edge of the sheet to the opposite edge, either in the machine direction or in the cross-machine direction. It is to be understood that in such embodiments, the regions of first basis weight may be separated from each other by regions of a different basis weight, e.g. by regions of a second basis weight or regions of a third basis weight. In some embodiments, the alternating stripes may form a regular pattern, i.e. continuous pattern, or in some embodiments, they may form an irregular pattern, i.e. a discontinuous pattern. One example of wipes wherein the regions 12 of a first basis weight are in the form of stripes in a regular pattern is illustrated on FIG. 3.

In the various embodiments wherein the side panels of the sheet comprises several regions of a first basis weight, e.g. from about 2 to about 200, or from about 2 to about 100, or from about 2 to about 50 regions, the total surface area of said regions of a first basis weight may represent from about 8% to about 70% of the total surface area of the sheet, or from about 20% to about 65% of the total surface area of the sheet or from about 25% to about 60% of the total surface area of the sheet.

Central Panel

The central panel as used herein is defined by the area of the sheet comprised between the two side panels 7, 8. The central panel is referred as reference number 9 on FIGS. 1 to 4. As mentioned above, the overall dimensions of the sheet and panels thereof, i.e. side panels and central panel, are dependent on the intended application of the wipe and can be selected accordingly. However, typically, the central panel 9 has a surface area representing from about 20% to about 90% of the total surface area of the sheet, or from about 30% to about 80% of the total surface area of the sheet, or from about 40% to about 70% of the total surface area of the sheet.

The central panel 9 comprises one region 14 of a second basis weight representing from about 25% to about 100% of the total surface area of the central panel, or from about 35% to about 100% of the total surface area of the central panel, or from about 50% to about 100% of the total surface area of the central panel. The second basis weight is higher than the first basis weight disclosed herein. Thus, in some embodiments, the central panel may consist of a region of a second basis weight and in some embodiments it may comprise one region of a second basis weight, said one region being continuous and representing from about 25% to less than 100% of the total surface area of the central panel, or from about 35% to less than 100% of the total surface area of the central panel, or from about 50% to less than 100% of the total surface area of the central panel and one or more regions of a different basis weight. In some embodiments, the region of a second basis weight in said central panel represents about 50%, or about 60% or about 80% of the total surface area of the central panel. Typically, the region of a second basis weight represents from about 10% to about 90% of the total surface area of the sheet, or from about 20% to about 80% of the total surface area of the sheet, or from about 25% to about 70% of the total surface area of the sheet. FIGS. 1 to 4 are illustrative of such embodiments. In some embodiments, the central panel 9 consists of one region 14 of a second basis weight wherein said second basis weight is higher than the first basis weight, as shown on FIGS. 1 to 3.

Generally, when the central panel 9 comprises one region 14 of a second basis weight representing from about 25%, or from about 35%, or from about 50% to less than 100% of the total surface area of the central panel, said region 14 of a second basis weight extends in the plane of the sheet from the center C of the sheet towards the edges of the sheet and towards the virtual lines delimiting the central panel from the side panels. By center of the sheet as used herein, it is meant the point C wherein the diagonals 15, 16 of the sheet intersect in the plane. In some embodiments, where the region 14 of a second basis weight of the central panel is rectangular or square in shape, the center C′ of said region 14 of a second basis weight may be congruent with the center C of the sheet, i.e. the center C′ of the second region and the center C of the sheet are a single and same point (see FIG. 4).

In embodiments wherein the central panel comprises one region 14 of a second basis weight representing from about 25%, or from about 35%, or from about 50% to less than 100% of the total surface area of the central panel, the central panel may further comprise one or more regions, such as two regions, of a first basis weight or one or more regions, such as two regions of a third basis weight, the first and third basis weight being lower than the second basis weight. Most commonly, these regions of a first basis weight, or of a third basis weight, of the central panel lie close to the edges of the sheet (for example along one edge or two edges of the sheet). FIG. 4 illustrates an embodiment of a wipe 1 wherein the central panel 9 comprises one region 14 of a second basis weight and two regions 17 of a first basis weight.

In the different embodiments of the present disclosure, the second basis weight is higher then the first basis weight. The ratio of first basis weight to second basis weight may vary as desired. However, typically, the first basis weight may be from about 1.2 to about 10 times lower than the second basis weight, or from about 1.5 to about 5 times lower than the second basis weight, or from about 2 to about 3 times lower than the second basis weight.

Typically, the regions of a first basis weight may have a basis weight between about 15 to about 60 g/m², or between about 20 to about 50 g/m², or between about 25 to about 40 g/m². The regions of a second basis weight may have a basis weight between about 30 to about 100 g/m², or between about 35 to about 70 g/m², or between about 40 to about 80 g/m².

Through experimentation, it has been tried to manufacture wipes having a right balance of properties at low costs. It has now be found that by providing wipes having different basis weight in target regions, i.e. a higher basis weight in the central panel vs. the side panels, the above needs are met. The target regions are defined to yield the performances properties which render the fibrous structure suitable for its intended purpose.

It was observed that typically consumers do not use the whole surface area of a wipe when performing a cleaning task: consumers use the central portion of the wipe when wiping a surface, the edges acting mainly as barriers to protect the hands from soiling during the cleaning task.

It has been found that the distinctive wipes of the present disclosure, i.e. wipes having side panels of lower basis weight vs. the central panel, offer the possibility of associating efficient cleaning and efficient hands protection with fibers usage decrease and with reduction of manufacturing costs. Indeed, the central panel of the sheet/wipe of the present disclosure has a high basis weight relative to the side panels of the wipes/sheets. Thus, the central panel provides for strength, softness, opacity, thickness, efficient cleaning whereas the side panels provide for economization of fibers. However, the side panels still perform their intended functions, for instance they offer suitable protection for users' hands during the cleaning task. When the wipes are intended to clean the floor, their central panel, which is generally the portion that comes in contact with the floor and dirt, maintains suitable caliper and structure providing desired cleaning performance and the side panels, which are typically used to removably attached the wipe to the cleaning implement, e.g. wrapped around the mop head, and not used for cleaning, contribute to save large amount of material.

As known to the skilled person, fibrous structures having regions of different basis weight may be produced by a variety of suitable processes. For instance, any processes producing a non-uniform lay-down of fibers or any processes which control the formation of a fibrous structure made from filaments and/or fibers by the application of an air flow such as is generated by a vacuum are suitable. The fibrous structure may be produced according to a meltblown process, air laid process, bonded carded process, coform process. Examples of suitable processes are disclosed in WO 00/20675 and U.S. Pat. No. 6,331,268 B1. Differential basis weight fibrous structures may also be produced by using differential aperturing technologies such as disclosed in U.S. Pat. No. 5,628,097, or U.S. Pat. No. 5,916,661 or U.S. Pat. No. 6,884,494.

Fibrous structures having regions of different basis weight may also be manufactured by a method referred to as mechanical activation of a fibrous material. Mechanical activation, or incremental stretching as it is sometimes referred to, involves permanently stretching or elongating a fibrous structure or regions of a fibrous structure in one or more directions, i.e. machine direction or cross-machine direction. As the fibrous material is stretched or elongated, some of the fibers, inter-fiber bonds, and/or intra-fiber bonds are believed to be broken. For instance, the fibrous material in the region(s) of a first basis weight may be elongated relative to the fibrous material in the region(s) of a second basis weight. As a consequence of the elongation of the fibrous material, the basis weight of the sheet in said region(s) comprising the elongated fibrous material is reduced. The fibrous material in the region(s) of a first basis weight may be elongated by a factor comprised from about 10 to about 200%, or from about 15 to about 100%, or from about 20 to about 90% relative to the fibrous material in the region(s) of a second basis weight. The percentages of elongation as mentioned immediately above are the effective elongations of the fibrous material after the elongation process, thus taking in consideration the relaxation that may arise subsequent to the elongation. It is to be understood that the elongation of the fibrous material is limited intrinsically by the nature of the fibrous material, e.g. type of fibers and/or by the manufacturing process but also by the desirable end properties of the substrate material. The fibrous material according to the present disclosure may be elongated in the cross-machine direction and/or in the machine direction. As used herein with respect to fibrous materials, the term “machine-direction” refers to the direction of travel as the fibrous material is produced, for example on nonwoven making equipment. Likewise, the term “cross-direction” refers to the direction in the plane of the fibrous material perpendicular to the machine-direction. With respect to individual wipes or sheets, the terms “machine-direction” and “cross-machine direction” refer to the corresponding directions of the wipes/sheets with respect to the fibrous material the wipe/sheet was made from. In one embodiment, the fibrous material of the sheet is elongated in the cross-machine direction.

Known processes for activating a fibrous material typically involve passing the fibrous material through one or more pairs of activation rolls. The activation rolls generally have three-dimensional surface features (e.g., teeth and grooves, peaks and channels, or corrugations), which are configured to operatively engage one another. The three-dimensional surface features on the rolls are typically complementary (i.e., fit together in an intermeshing fashion) such that the rolls are sometimes referred to as being a “matched” or “mated” pair. As the fibrous structure passes through the matched pair of activation rolls, it is subjected to relatively high localize mechanical stress from the intermeshing three-dimensional surface features. Most, if not all, of the fiber/bond breaking takes place in these areas of high localized mechanical stress. Upon successful completion of the activation process, the activated fibrous structure exhibits an increase in length (elongation) in one or more dimension, i.e. machine direction or cross machine direction, depending on the direction of activation.

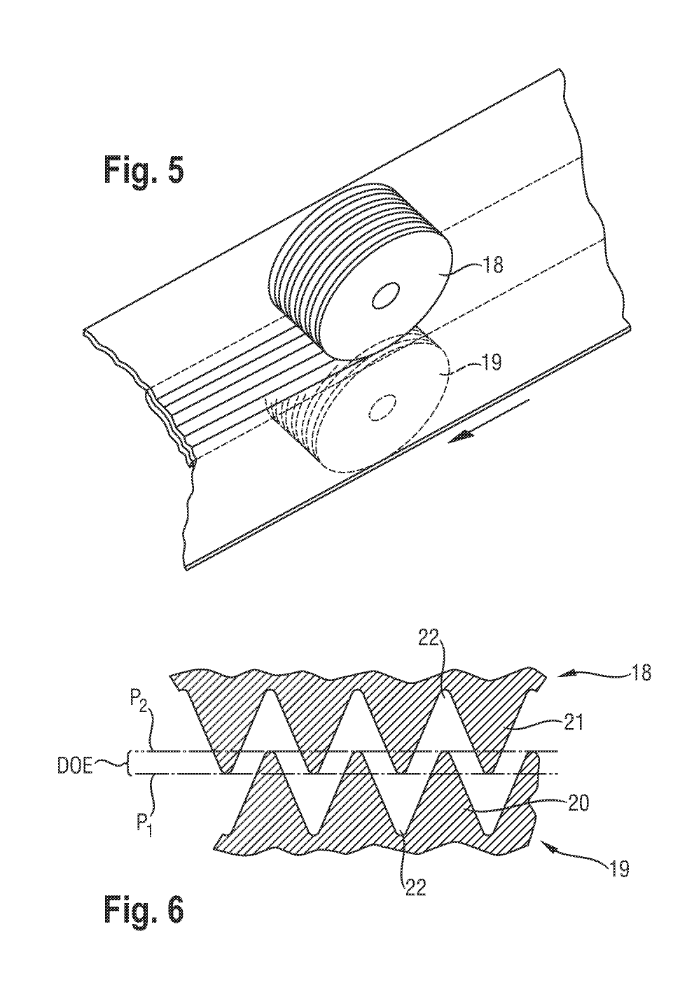

The one or more regions of a first basis weight of the sheet making the wipe according to the present disclosure may be achieved by activating portions of the fibrous material. For activating portions of the fibrous material, the fibrous material is first fed through a pair of matched activation rolls that have raised portions extending in the “axial direction” of the rolls (i.e., parallel to the axis of rotation of the rolls) to activate the fibrous material in a first direction at the intended location. For instance, the portion to be activated is passed between a pair of activation rolls having three-dimensional surfaces. The axially extending raised portions of the rolls intermesh in a manner similar to the way the teeth of two gears typically intermesh. The rolls may be positioned such that the intermeshing teeth do not substantially contact one another in order to avoid damaging the teeth and/or roll. An example of a process for mechanically activating portions of a fibrous material is schematically represented in FIGS. 5 and 6. The degree of activation may be adjusted by varying the number of engaging portions and recess portions and the depth of engagement of the activation rolls 18, 19 on the fibrous material. While the exact configuration, spacing and depth of the complementary grooves on the uppermost and lowermost activation rolls will vary, depending upon such factors as the amount of elongation desired, two pairs of activation rolls, each having a peak-to-peak groove pitch of approximately 3.8 mm, an included angle of approximately 18° as measured at the peak, and a peak-to-valley groove depth of approximately 7.6 mm have been employed in one embodiment of the present disclosure. With reference to FIG. 6, which shows a portion of the intermeshing of the engaging portions 20 and 21 of activation rolls 18 and 19, respectively, the term “pitch” refers to the distance between the apexes of adjacent engaging portions. The pitch can be between approximately 0.02 to approximately 0.30 inches (0.51-7.62 mm), and may be between approximately 0.05 and approximately 0.15 inches (1.27-3.81 mm). The height (or depth) of the teeth is measured from the base of the tooth to the apex of the tooth, and may be equal for all teeth. The height of the teeth can be between approximately 0.10 inches (2.54 mm) and approximately 0.90 inches (22.9 mm), and may be approximately 0.25 inches (6.35 mm) and approximately 0.50 inches (12.7 mm). The engaging portions 20 in one activation roll can be offset by one-half the pitch from the engaging portions 21 in the other activation roll, such that the engaging portions of one pressure applicator (e.g., engaging portion 20) mesh in the recess portions 22 (or valleys) located between engaging portions in the corresponding activation roll. The offset permits intermeshing of the two activation rolls when the activation rolls are “engaged” or in an intermeshing, operative position relative to one another. In one embodiment, the engaging portions of the respective activation rolls are only partially intermeshing. The degree to which the engaging portions on the opposing activation roll intermesh is referred to herein as the “depth of engagement” or “DOE” of the engaging portions. As shown in FIG. 6, the DOE is the distance between a position designated by plane P1 where the apexes of the engaging portions on the respective activation rolls are in the same plane (0% engagement) to a position designated by plane P2 where the apexes of the engaging portions of one activation roll extend inward beyond the plane P1 toward the recess portions on the opposing activation roll.

As the fibrous structure passes through the pair of rolls, it is activated in the direction of travel of the fibrous material, referred to as the machine-direction. In some instances, a matched pair of rolls may include surface features that resemble a line of alternating discs of larger and smaller diameters, sometimes referred to as a ring-rolling configuration. Ring-rolling is typically used to activate a fibrous structure in the direction orthogonal to the machine direction, also referred to as the cross-machine direction.

The elongated fibrous material may slightly relax as it “exits” the activation rolls. One of ordinary skill in the art will appreciate that other processes for mechanically activating a fibrous material may be used and still provide the same benefits.

### EXAMPLE

A fibrous material made of 80% Polypropylene/20%Viscose, 45 gsm as supplied by Ahlstrom, having an original width of 162 mm was passed between the activation rolls illustrated on FIG. 6. The activation rolls have a peak separation of 0.100 inches (2.54 mm) and a diameter of 6.0 inches (152.4 mm). Each roll is 10.0 inches (254 mm long). The grooved rolls have a peak separation of 0.100 inches (2.54 mm). The fibrous material speed at the entrance of the apparatus was 80 m/min. The fibrous material was thus elongated in the cross-machine direction to provide a fibrous material having a total width of 180 mm, of which 90 mm of elongated areas along opposite edges of the fibrous material (two margins having respectively a width of 45 mm), thus providing about 10% of material savings. The fibrous material in the elongated region is elongated by about 25% relative to the fibrous material in the non-elongated region.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A wipe comprising a sheet of fibrous material, said sheet having two side panels and a central panel, wherein
each of said side panels comprises at least one region of a first basis weight;
said central panel comprises one region of a second basis weight, said region of a second basis weight representing from 25 to 100% of the total surface area of the central panel;
and wherein said first basis weight is lower than said second basis weight.

2. The wipe according to claim 1 wherein each of said side panels represents up to 40% of the total surface area of the sheet.

3. The wipe according to claim 1 wherein said central panel further comprises one or two regions of a first basis weight.

4. The wipe according to claim 1 wherein said region of a second basis weight is rectangular or square in shape.

5. The wipe according to claim 1 wherein said region of a second basis weight has a center which is congruent with the center of said sheet.

6. The wipe according to claim 1 wherein each of said side panels comprise from 1 to 200 regions of a first basis weight.

7. The wipe according to claim 1 wherein each of said side panels comprise from 1 to 200 regions of a first basis weight and wherein said regions of a first basis weight are in the form of stripes extending from one edge of the sheet to the opposite edge.

8. The wipe according to claim 1 wherein each of said side panels comprise from 1 to 200 regions of a first basis weight, wherein said regions of a first basis weight are in the form of stripes extending from one edge of the sheet to the opposite edge and are separated from each others by regions of a second basis weight.

9. The wipe according to claim 1 wherein each of said side panels comprise from 1 to 200 regions of a first basis weight, wherein said regions of a first basis weight are in the form of stripes extending from one edge of the sheet to the opposite edge and are separated from each others by regions of third basis weight, wherein said third basis weight is higher than said first basis weight and lower than said second basis weight.

10. The wipe according to claim 1 wherein the first basis weight is from 1.2 to about 10 times lower than the second basis weight.

11. The wipe according to claim 1 wherein said fibrous material is a nonwoven material selected from the group consisting of meltblown web, air laid web, spunbond web, carded web, coform web or any combinations thereof.

12. The wipe according to claim 1 further comprising a water-based composition.

13. The wipe according to claim 1 wherein each of said side panels represents 30% of the total surface are of the sheet.
